(19) United States
(12) Patent Application Publication
(10) Pub. No.: US 2026/0267282 A1
(43) Pub. Date: Sep. 10, 2026

(54) IMAGE FORMING APPARATUS

(71) Applicant: CANON KABUSHIKI KAISHA, Tokyo (JP)

(72) Inventor: HIROKI HANAYAMA, Kanagawa (JP)

(21) Appl. No.: 19/447,131

(22) Filed: Jan. 13, 2026

(30) Foreign Application Priority Data
Mar. 4, 2025 (JP) 2025-033730

(51) Int. Cl. G03G 21/18; G03G 15/00; G03G 21/16

(52) U.S. Cl. CPC G03G 21/1875; G03G 15/80; G03G 21/1633; G03G 21/1652; G03G 21/1814; G03G 21/1867; G03G 2221/163; G03G 2221/166; G03G 2221/1693; G03G 2221/1892

(57) ABSTRACT

An image forming apparatus which a cartridge provided with first and second members is mountable to and dismountable from includes an open/close portion for taking an open state in which the cartridge is mountable to and dismountable from the image forming apparatus and a closed state in which the cartridge is restricted from being mounted to and dismounted from the image forming apparatus. A first circuit generates a first voltage to be supplied to the first member. A second circuit provided with a switching element to generate a second voltage, to be supplied to the second member, by dividing the first voltage. A controller controls turn on and turn off of the switching element. A detecting portion detects the open state of the open/close portion. The controller controls the switching element so as to turn on when the detecting portion detects the open state of the open/close portion.

### BACKGROUND

### Field of the Technology

The present invention relates to an image forming apparatus, and for example, to an image forming apparatus using an electrophotographic type.

### Description of the Related Art

Conventionally, a configuration in which a plurality of voltages are generated from a single high voltage circuit to realize cost reduction has been proposed. In Japanese Patent Application Laid-Open No. 2014-238490, a charging voltage is generated by a transformer, and a developing voltage is generated by dividing the charging voltage with a resistor and a switching element. Here, the charging voltage is applied to a charging roller, and the developing voltage is applied to a developing roller. In addition, a configuration in which an overvoltage protection circuit is added to protect the switching element when an overvoltage is applied to the switching element has been proposed. In Japanese Patent Application Laid-Open No. 2011-187833, a Zener diode is connected between terminals of the switching element, and the switching element is protected from the overvoltage by configuring the switching element to be passively turned on upon the overvoltage being applied to the switching element.

### SUMMARY

In a configuration using an electric element in which an overvoltage protection circuit operates passively, the following problem arises. That is, in a case in which steep electrical noise such as electrostatic discharge (hereinafter, referred to as ESD) is applied to the switching element, there is a possibility that a protection operation may not respond in time. In addition, a cost of a component added as a protective element is incurred.

The present disclosure is conceived under such background, and an object thereof is, in a circuit configuration in which another voltage is generated from a single high voltage circuit, with an inexpensive configuration, to protect a switching element even against steep electrical noise.

In order to solve the aforementioned problem, the present Embodiment includes the following configuration.

(1) An image forming apparatus which a cartridge provided with a first member and a second member is mountable to and dismountable from, the image forming apparatus comprising: an open/close portion configured to take an open state in which the cartridge is mountable to and dismountable from the image forming apparatus and a closed state in which the cartridge is restricted from being mounted to and dismounted from the image forming apparatus; a first circuit configured to generate a first voltage to be supplied to the first member; a second circuit provided with a switching element configured to generate a second voltage, to be supplied to the second member, by dividing the first voltage; a controller configured to control turn on and turn off of the switching element; and a detecting portion configured to detect the open state of the open/close portion, wherein the controller controls the switching element so as to be turned on when the detecting portion detects the open state of the open/close portion.

Further features of the present invention will become apparent from the following description of exemplary embodiments with reference to the attached drawings. The following description of embodiments is described by way of example.

### BRIEF DESCRIPTION OF THE DRAWINGS

FIG. 1 is a cross-sectional outline configuration view of an image forming apparatus in Embodiments 1 and 2.

FIG. 2 is a circuit diagram of an image forming portion in the Embodiments 1 and 2.

FIG. 3 is a circuit diagram of a door open/close detecting circuit in the Embodiment 1.

FIG. 4 is a flowchart showing a control in the Embodiment 1.

FIG. 5 is a flowchart showing a control in the Embodiment 2.

### DESCRIPTION OF THE EMBODIMENTS

Hereinafter, the present Embodiment will be described in detail with reference to the drawings. Hereinafter, a voltage output from a single high voltage circuit, which includes a transformer and is connected to an alternating current voltage, is also referred to as a source voltage. Being connected to a lower level of the source voltage is also referred to as being dependent.

In addition, in the following description and each drawing, a vertical direction in a case in which an image forming apparatus is installed on a horizontal plane is defined as a Z direction. A direction crossing the Z direction and a direction of a rotational axis of a photosensitive drum (rotational axis direction of the photosensitive drum), which will be described below, is defined as a Y direction. A direction crossing both the Z direction and the Y direction is defined as an X direction. The X direction and the Y direction are preferably horizontal directions. In addition, the X direction, the Y direction and the Z direction are preferably perpendicular to each other. In addition, as necessary, directions of arrows X, Y and Z illustrated in each drawing are expressed as a +X side, a +Y side and a +Z side, respectively, and opposite sides thereof are expressed as a -X side, a -Y side and a -Z side, respectively.

### Embodiment 1

### Configuration of an image forming apparatus

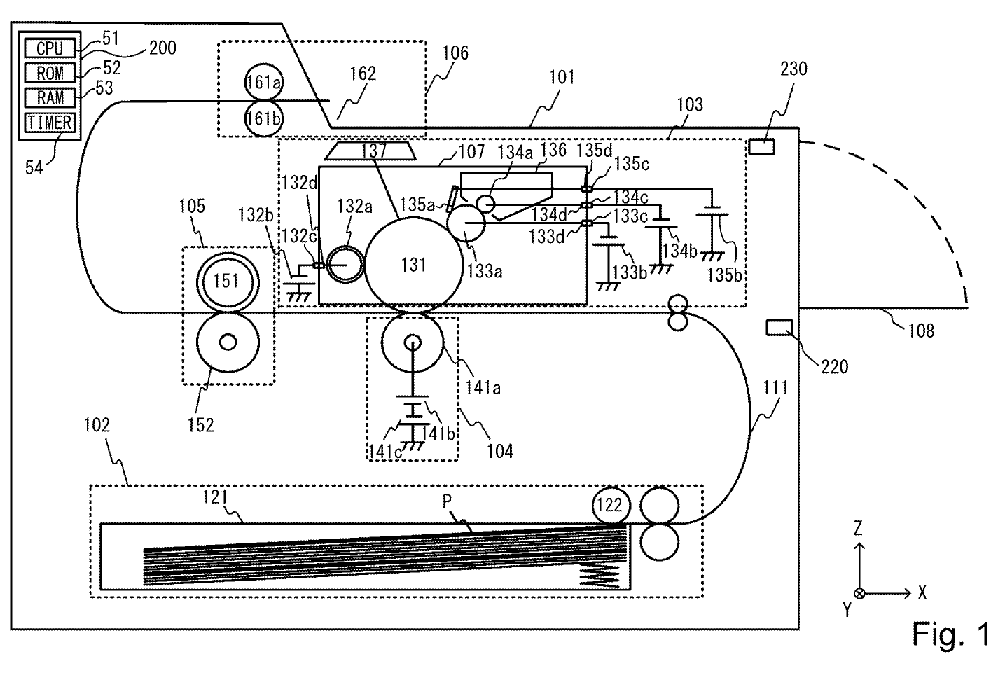

In FIG. 1, a cross-sectional outline view of an image forming apparatus 101 is illustrated. The image forming apparatus 101 is configured to execute an image forming operation for forming an image on a sheet P as a recording material. The image forming apparatus 101 is an example of an image forming apparatus which a cartridge including a first member and a second member is mountable to and dismountable from. A sheet feeding portion 102 includes a sheet feeding tray 121 and a sheet feeding roller 122, and in the sheet feeding tray 121, the sheet P of a printing target is accommodated. An image forming portion 103 is constituted by a photosensitive drum 131, a charging roller 132a, a developing roller 133a, a supplying roller 134a, a developing blade 135a, a toner container 136, a laser scanner 137, etc. In addition, the image forming apparatus 101 is provided with an openable and closable door 108. FIG. 1 illustrates a state in which the door 108 is open. The door 108 is an example of an open/close portion which takes an open state in which a cartridge is mountable to and dismountable from the image forming apparatus and a closed state in which the cartridge is restricted from being mounted to and dismounted from the image forming apparatus.

To the charging roller 132a, a high voltage generated by a charging circuit 132b is applied. The charging roller 132a is an example of the first member which uniformly charges a surface of the photosensitive drum 131. To the developing roller 133a, a high voltage generated by a developing circuit 133b is applied. The developing roller 133a is an example of the second member which develops a latent image formed on the photosensitive drum 131 with toner. To the supplying roller 134a, a high voltage generated by a supplying roller circuit 134b is applied. To the developing blade 135a, a high voltage generated by a blade circuit 135b is applied.

The cartridge 107 includes a part of the image forming portion 103, and is mountable to and dismountable from the image forming apparatus 101 by opening the door 108. Specifically, when the door 108 is open, by the cartridge 107 being moved to the +X side, the cartridge 107 is dismounted from the image forming apparatus 101. In addition, when the door 108 is open, by the cartridge 107 being moved to the -X side, the cartridge 107 is mounted to the image forming apparatus 101. The cartridge 107 is an example of a unit, which includes the first member and the second member, which are operated during image forming operation, and is mountable to and dismountable from the image forming apparatus.

The image forming apparatus 101 includes an output contact 132c of the charging circuit 132b, an output contact 133c of the developing circuit 133b, an output contact 134c of the supplying roller circuit 134b, and an output contact 135c of the blade circuit 135b. The output contact 132c is an example of a first electric contact for electrically connection to the first member, and the output contact 133c is an example of a second electric contact for electrically being connected to the second member. The output contacts 132c, 133c, 134c and 135c are exposed, in a state in which the door 108 is in an open state and the cartridge 107 is dismounted, so as to be contactable by a user. In other words, in a state in which the open/close portion is in the open state and the cartridge is dismounted from the image forming apparatus, the first electric contact and the second electric contact are exposed so as to be contactable by the user.

On the other hand, the cartridge 107 includes a contact 132d being connected to the charging roller 132a, a contact 133d being connected to the developing roller 133a, a contact 134d being connected to the supplying roller 134a, and a contact 135d being connected to the developing blade 135a. When the cartridge 107 is mounted to the image forming apparatus 101, the output contacts 132c, 133c, 134c and 135c of the respective circuits are connected to the contacts 132d, 133d, 134d and 135d of the cartridge 107, respectively. As a result, it becomes a state in which electric power is suppliable from the respective circuits to each member. That is, when the cartridge is mounted to the image forming apparatus, a switching element (details will be described later) is electrically connected to the first electric contact and the second electric contact.

A transfer portion 104 includes a transfer roller 141a, and a high voltage generated by a transfer positive circuit 141b and a transfer negative circuit 141c, which is connected to the transfer positive circuit 141b in series, is applied to the transfer roller 141a. Here, it may be configured that the transfer negative circuit 141c is connected to the transfer positive circuit 141b in parallel and connection thereof to the transfer roller 141a is switched by a switch, or that the transfer negative circuit 141c itself is absent. In addition, the transfer roller 141a is opposite to and in contact with the photosensitive drum 131. A fixing portion 105 includes a fixing roller 151 and a pressing roller 152. In addition, a discharging portion 106 includes discharging rollers 161a and 161b and a discharge tray 162. A locus drawn by a leading end (or a trailing end) of the sheet P inside the image forming apparatus 101 until the sheet P is conveyed from the sheet feeding tray 121, image formation is completed, and the sheet P is discharged to the discharge tray 162 is defined as a conveyance path 111. In addition, a door open/close detecting circuit 220 and a mounting/dismounting detecting portion 230 will be described below.

### Operation of the image forming apparatus

An operation (image forming operation) in which a toner image is formed on the surface of the photosensitive drum 131 by the image forming portion 103 will be described. To the charging roller 132a, a negative high voltage is applied from the charging circuit 132b. The charging roller 132a charges the surface of the photosensitive drum 131. A charging process in the Embodiment 1 employs a roller charging type. The charging roller 132a and the photosensitive drum 131 are opposite to each other with a slight gap, and the charging roller 132a uniformly charges the surface of the photosensitive drum 131 using an electric discharge in the gap. The laser scanner 137 causes the photosensitive drum 131 to be irradiated with laser in accordance with image data, and forms the latent image on the surface of the photosensitive drum 131 (on the photosensitive drum).

The toner accommodated in the toner container 136 is negatively charged by agitation. To the supplying roller 134a, a negative high voltage is applied from the supplying roller circuit 134b. By the supplying roller 134a moving the toner to the surface of the developing roller 133a, the toner is adhered to a surface of the developing roller 133a. To the developing blade 135a, a negative high voltage is applied by the blade circuit 135b. Since heights of the toner adhered to the surface of the developing roller 133a is uneven depending on location, the toner is leveled evenly by the developing blade 135a. The developing roller 133a, of which the toner has been adhered to the surface, by utilizing the negative high voltage applied from the developing circuit 133b, causes the toner to be moved to the surface of the photosensitive drum 131, and develops the latent image.

Here, by setting an absolute value of an output voltage of the supplying roller circuit 134b to be larger than that of an output voltage of the developing circuit 133b, it becomes easier for the toner, which is negatively charged, to be moved to the developing roller 133a. In addition, by setting an absolute value of an output voltage of the blade circuit 135b to be larger than that of the output voltage of the developing circuit 133b, it becomes less likely for the toner, which is negatively charged, to be fixedly adhered to the developing blade 135a. For example, the output voltage of the developing circuit 133b is set to -300 V, and the output voltages of the supplying roller circuit 134b and the blade circuit 135b are set to -400 V.

Next, the image forming operation, in which the image is formed on the sheet P, will be described. When the image forming apparatus 101 receives a print job, the respective rollers and the laser scanner 137 start the operations thereof. The sheet P accommodated in the sheet feeding tray 121 is fed by the sheet feeding roller 122, passes through the conveyance path 111, and reaches a position at which the photosensitive drum 131 and the transfer roller 141a are opposite to each other (hereinafter, also referred to as a transfer nip portion). To the transfer roller 141a, a positive high voltage is applied from the transfer positive circuit 141b. The sheet P is nipped by the photosensitive drum 131 and the transfer roller 141a, and at that time, the toner image formed on the surface of the photosensitive drum 131 is transferred to the sheet P. The sheet P, which continues to be conveyed, subsequently reaches a position at which the fixing roller 151 of the fixing portion 105 and the pressing roller 152 are opposite to each other (hereinafter, also referred to as a fixing nip portion). The sheet P is pressed and nipped by the fixing roller 151 and the pressing roller 152, and the toner image is fixed to the sheet P. Thereafter, the sheet P is discharged, via the discharging rollers 161a and 161b, to the discharge tray 162.

The image forming apparatus 101 is provided with a control portion 200. The control portion 200 includes a CPU 51 (central processing unit), a ROM 52 (read only memory), a RAM 53 (random-access memory), and a timer 54. The control portion 200 executes, with the CPU 51, a program stored in advance in the ROM 52 while using the RAM 53 as a temporary working area, and controls the image forming apparatus 101. The control portion 200 performs, upon performing the control of the image forming apparatus 101, control of various types of timings while using the timer 54. Incidentally, the control portion 200 may be provided with an ASIC (application specific integrated circuit) and/or an MPU (micro processing unit). Numbers of the CPU 51, the timer 54, the ROM 52, and the RAM 53 are not limited to one, but may be plural. In addition, as a storage medium, another storage medium such as a hard disk and an optical disk may be used. The control portion 200 is an example of a control portion which controls turn on and turn off of the switching element.

### Configuration and operation of the charging circuit

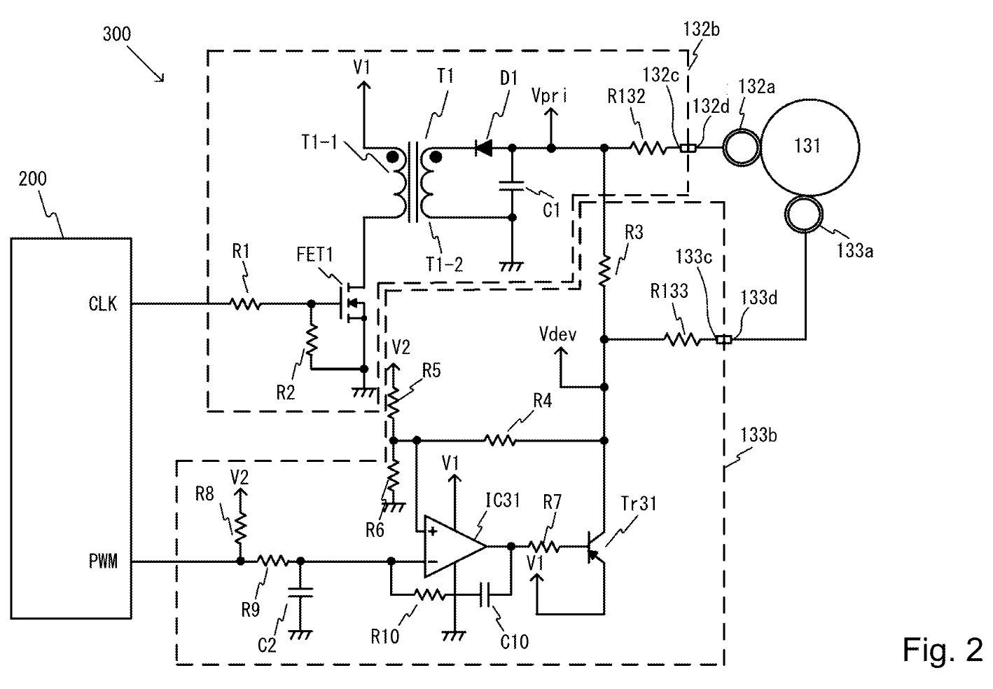

In the image forming portion 103, a configuration and an operation of the charging circuit 132b will be described using FIG. 2. FIG. 2 is a diagram illustrating a power source device 300 which includes the charging circuit 132b and the developing circuit 133b.

The charging circuit 132b includes a transformer T1, a field effect transistor (hereinafter, referred to as an FET) 1, resistors R1, R2 and R132, a diode D1, and a capacitor C1. The transformer T1 includes a primary winding T1-1 and a secondary winding T1-2. A power source voltage V1 is connected to one terminal of the primary winding T1-1, and a drain terminal of the FET 1 is connected to the other terminal thereof. To a gate terminal of the FET 1, a source terminal thereof is connected via the resistor R2, and a CLK terminal of the control portion 200 is connected thereto via the resistor R1. On the other hand, between both terminals of the secondary winding T1-2, the diode D1 and the capacitor C1 are connected. A cathode terminal of the diode D1 is connected to one terminal of the secondary winding T1-2, and an anode terminal of the diode D1 is connected to one terminal of the capacitor C1. The other terminal of the capacitor C1 is connected to ground (hereinafter, referred to as GND). Incidentally, the power source voltage V1 in the Embodiment 1 is 24 V.

A pulse signal is output from the CLK terminal of the control portion 200. When a signal of high level is output from the CLK terminal, the FET 1 is turned on, and a drain voltage of the FET 1 drops to approximately the same potential as the GND. As a result, a voltage is applied to both ends of the primary winding T1-1 of the transformer T1, and an excitation current flows. In this state, when the voltage output from the CLK terminal is changed to a low level, the FET 1 is turned off, and a flyback voltage is generated at both ends of the primary winding T1-1. Along with this operation, in the secondary winding T1-2 as well, a flyback voltage corresponding to a winding ratio of the primary winding T1-1 and the secondary winding T1-2 is generated. The flyback voltage generated in the secondary winding T1-2 is rectified and smoothed by the diode D1 and the capacitor C1, and a charging voltage Vpri, which is a first voltage, is generated.

The voltage output from the CLK terminal of the control portion 200 is a rectangular wave in which the high level and the low level are generated alternately. In the Embodiment 1, a fixed rectangular wave having a frequency of 50 kHz and a duty (on duty) of 10% is output. Incidentally, the frequency and the duty of the rectangular wave should be designed to optimal values in each circuit, and the values in the Embodiment 1 are described as just an example. Further, these values need not be fixed values, and may be configured to be variable depending on a voltage and/or a load of a control target. By the FET 1 being turned on and turned off, the flyback voltage generated in the secondary winding T1-2 is rectified and smoothed by the diode D1 and the capacitor C1, and the charging voltage Vpri is generated. Through the operation described above, the charging voltage Vpri is generated and applied to the charging roller 132a via the resistor R132. Incidentally, the resistor R132 may be incorporated as necessary in order to limit the output current.

### Configuration and operation of the developing circuit

In the image forming portion 103, a configuration and an operation of the developing circuit 133b will be described using FIG. 2. The developing circuit 133b is a circuit which generates a developing voltage Vdev, which is a second voltage having negative polarity, by reducing the charging voltage Vpri by voltage dividing by a resistor R3 and a switching element Tr31. In the developing circuit 133b, in order to control the developing voltage Vdev to a stable and predetermined voltage, the developing voltage Vdev is under feedback control.

The developing circuit 133b includes the switching element Tr31, resistors R3, R4, R5, R6, R7, R8, R9, R10 and R133, capacitors C2 and C10, and an operational amplifier IC31. The switching element Tr31 is a PNP transistor in the Embodiment 1, and a collector terminal thereof is connected to the charging voltage Vpri via the resistor R3. Of the switching element Tr31, an emitter terminal is connected to the power source voltage V1, and a base terminal is connected to an output terminal of the operational amplifier IC31 via the resistor R7.

A non-inverting input terminal of the operational amplifier IC31 is connected to the collector terminal of the switching element Tr31 via the resistor R4, connected to a power source voltage V2 via the resistor R5, and further connected to the GND via the resistor R6. Here, the power source voltage V2 in the Embodiment 1 is 5 V. An inverting input terminal of the operational amplifier IC31 is connected to the output terminal of the operational amplifier IC31 via the resistor R10 and the capacitor C10, connected to the GND via the capacitor C2, and further connected to the power source voltage V2 via the resistor R9 and the resistor R8. The resistor R10 and the capacitor C10 are provided for phase compensation of the operational amplifier IC31, and contribute to stabilization of the feedback control. The operational amplifier IC31 is operated by the power source voltage V1.

In addition, a connected point between the resistor R8 and the resistor R9 is connected to a PWM terminal of the control portion 200. From the PWM terminal, a pulse signal, which alternately repeats a high impedance (hereinafter, referred to as Hi-Z) state and a low level, is output. When the PWM terminal is in the Hi-Z state, a current charging the capacitor C2 flows from the power source voltage V2 via the resistor R8 and the resistor R9. On the other hand, when the PWM terminal is at the low level, a current discharging the capacitor C2 flows toward the PWM terminal via the resistor R9. When the PWM terminal repeats the Hi-Z state and the low level, a balance of the charging and the discharging of the capacitor C2 is stabilized at a predetermined voltage. Therefore, depending on a duty of the pulse signal output from the PWM terminal, the voltage of the inverting input terminal of the operational amplifier IC31 is determined.

Since the output terminal of the operational amplifier IC31 controls the switching element Tr31 so that the non-inverting input terminal and the inverting input terminal are virtually grounded, it becomes possible to control the developing voltage Vdev to a desired voltage. Through the operation described above, the stable developing voltage Vdev is generated, and applied to the developing roller 133a via the resistor R133. Incidentally, the resistor R133 may be incorporated as necessary in order to limit an output current.

The charging circuit 132b is an example of a first circuit which generates the first voltage to be supplied to the first member. The developing circuit 133b is an example of a second circuit provided with a switching element which generates a second voltage by dividing the first voltage. The second circuit includes the resistor, and the second voltage is generated by the first voltage being divided by the voltage drop of the resistor and the switching element. The second circuit further provided with the operational amplifier provided with the input terminal and the output terminal, the control portion sends the signal to the input terminal of the operational amplifier, the output terminal is connected to the base terminal of the switching element, and the switching element switches the turn on state and the turn off state based on the signal transmitted from the output terminal.

### Configuration and operation of the door open/close detecting circuit

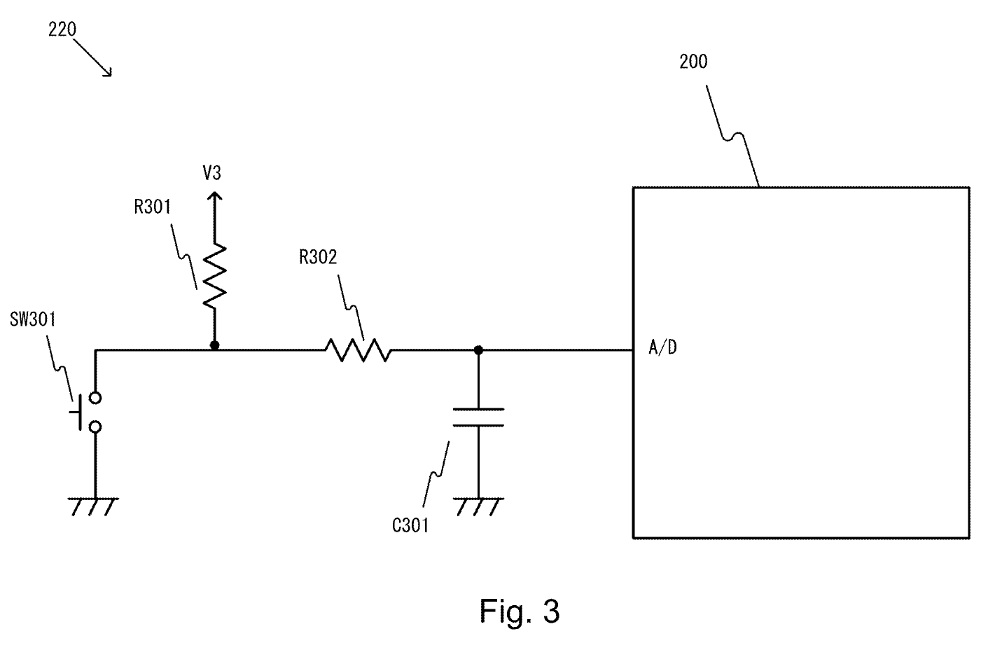

A configuration and an operation for detecting opening and closing of the door 108 will be described using FIG. 3. Incidentally, the following configuration is an example of a means to detect an open/close state of the door 108, and it may be detected by other means. The door open/close detecting circuit 220 includes resistors R301 and R302, a switch SW301, and a capacitor C301. The door open/close detecting circuit 220 is an example of a detection portion (first detecting portion) which detects an open state of the open/close portion. The door open/close detecting circuit 220 is configured so that, in response to the opening and closing of the door 108, pressing and releasing of the switch SW301 are switched. In the Embodiment 1, it is configured so that upon the door 108 being closed (hereinafter, also referred to as a closed state), the switch SW301 is pressed in conjunction with the door 108 becoming the closed state. In addition, upon the door 108 being opened (hereinafter, also referred to as the open state), the switch SW301 is released in conjunction with the door 108 becoming the open state.

One terminal of the SW301 is connected to the GND, and the other terminal thereof is connected to a power source voltage V3 via the resistor R301, and connected to the GND via the resistor R302 and the capacitor C301. In addition, a connected point between the resistor R302 and the capacitor C301 is connected to an A/D conversion terminal of the control portion 200. The resistor R301 is provided to pull up the other terminal of the switch SW301 to the power source voltage V3. The resistor R302 and the capacitor C301 serve as a low-pass filter in order not to transmit a steep fluctuation in a voltage of the other terminal of the switch SW301 to the A/D conversion terminal.

When the switch SW301 is pressed (the door 108 is in the closed state) and an impedance between both terminals of the switch SW301 becomes low, an electric charge of the capacitor C301 is pulled to the GND via the resistor R302 and the switch SW301. Therefore, a voltage input to the A/D conversion terminal becomes a low level. On the other hand, when the switch SW301 is released (the door 108 is in the open state) and the impedance between both terminals of the switch SW301 becomes high, a current charging the capacitor C301 flows from the power source voltage V3 via the resistor R301 and the resistor R302. When the capacitor C301 is sufficiently charged, the voltage input to the A/D conversion terminal becomes a high level. In this manner, it becomes possible for the control portion 200, by monitoring logic (high or low) of the A/D conversion terminal, to detect the opening and closing of the door 108. The door open/close detecting circuit 220 is an example of the detecting portion which detects the opening and closing of the door, and the control portion 200 determines whether or not the door is open based on a detection result of the detecting portion.

### Protecting control for the switching element in the Embodiment 1

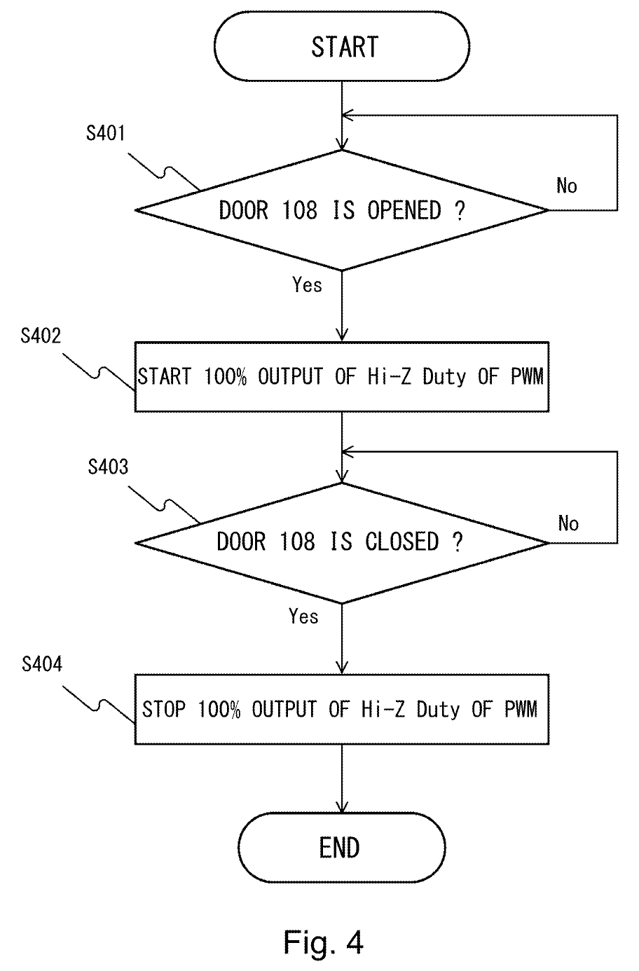

In the Embodiment 1, assuming a case in which electrical noise is injected into the developing circuit 133b as electrostatic discharge (ESD) when a person touches the output contact 133c. When the electrical noise is injected into the developing circuit 133b, an overvoltage is applied to the switching element Tr31 in the developing circuit 133b. In the Embodiment 1, in order to protect the switching element Tr31 from the overvoltage caused by the electrical noise, it is configured to control the switching element Tr31 so as to be turned on when the door 108 is open. This is because when the door 108 is open, access from an outside becomes possible, and a possibility that the electrical noise is generated increases. A control flow in the Embodiment 1 will be described using FIG. 4.

In step (hereinafter, referred to as S) 401, the control portion 200 determines whether or not the door 108 is open based on the detection result by the door open/close detecting circuit 220. In S401, if the control portion 200 determines that the door 108 is closed, the process returns to S401. In S401, if the control portion 200 determines that the door 108 is open, the process proceeds to S402. In S402, the control portion 200 outputs the PWM signal output from the PWM terminal so as to be Hi-Z state, i.e., so that the duty (illustrated as Duty) is 100%. As a result, the capacitor C2 is charged, and the voltage of the inverting input terminal of the operational amplifier IC31 becomes higher than the voltage of the non-inverting input terminal, whereby the switching element Tr31 is turned on. In other words, it can be said that the control portion causes the switching element to be turned on by sending the signal of which duty ratio is 1 to the input terminal of the operational amplifier when the detecting portion (first detecting portion) detects that the open/close portion is the open state. It can be said that the process in S402 is a control in which the control portion 200 causes the switching element Tr31 to be turned on. At this time, an impedance between the collector terminal and the emitter terminal of the switching element Tr31 becomes low. By this, it becomes possible to suppress the voltage applied to the switching element Tr31 by the ESD when a person touches the output contact 133c. Hereinafter, the operation in S402 performed by the control portion 200 when the door 108 is opened is referred to as a protecting operation.

That is, immediately after the door 108 is opened, since the protecting operation for the switching element Tr31 is performed before a person touches the output contact 133c, it becomes possible to protect the switching element Tr31 even against the application of the steep electrical noise such as ESD. Incidentally, in the Embodiment 1, the switching element Tr31 is turned on by outputting the PWM signal so that the duty of Hi-Z state becomes 100%, however, it is not limited thereto. As long as the switching element Tr31 can be turned on, the duty need not be 100%.

In S403, the control portion 200 determines whether or not the door 108 is closed. In S403, if the control portion 200 determines that the door 108 is open, then returns the process back to S403. In other words, the control portion 200 keeps the protecting operation for the switching element Tr31 while the door 108 is in the open state. In S403, if the control portion 200 determines that the door 108 is closed, then proceeds the process to S404. In S404, the control portion 200 stops the protecting operation for the switching element Tr31, specifically, in order to shift to the image forming operation, stops the output of the PWM signal, of which the duty of Hi-Z state is 100%, and terminates the process. It can be said that the process in S404 is a control in which the control portion 200 causes the switching element Tr31 to be turned off.

In this manner, the control portion 200 controls the switching element so as to turn on when the detecting portion detects the open state of the open/close portion. According to the Embodiment 1, in the circuit configuration in which another voltage is generated from the single high voltage circuit by voltage dividing by the resistor and the switching element, it becomes possible, with the inexpensive configuration, to protect the switching element even against the steep electrical noise. Incidentally, in the Embodiment 1, it is described that a first power source portion is the charging circuit 132b and a second power source portion is the developing circuit 133b, however, it is not limited thereto. The first power source portion may be any power source as long as the power source generates a source voltage (Vpri in the Embodiment 1). In addition, the second power source portion may be any power source as long as the power source is connected to a lower level than the first power source portion, and generates the second voltage by dividing the first voltage with the resistor and the switching element. The same applies as well to the following Embodiments.

As described above, according to the Embodiment 1, in the circuit configuration in which another voltage is generated from the single high voltage circuit, it becomes possible, with the inexpensive configuration, to protect the switching element even against the steep electrical noise.

### Embodiment 2

In the Embodiment 1, when the switching element Tr31 is turned on while the cartridge 107 is inserted, the power source voltage V1 is applied to the developing roller 133a (see FIG. 2). In an Embodiment 2, it will be described that a configuration in which, without changing the configuration of the Embodiment 1, without applying the power source voltage V1 to the developing roller 133a, it becomes possible to protect the switching element Tr31 from the voltage applied to the switching element Tr31 by the ESD.

In the Embodiment 2, the control portion 200 controls so as to cause the switching element Tr31 to be turned on when the cartridge 107 is dismounted from the image forming apparatus 101 and the door 108 is open. The image forming apparatus 101 is provided with the mounting/dismounting detecting portion 230 (see FIG. 1) for the cartridge 107. The mounting/dismounting detecting portion 230 is an example of a second detecting portion which detects that the cartridge is dismounted from the image forming apparatus, and the control portion 200 determines whether or not the cartridge 107 is dismounted based on a detection result of the detecting portion. In more detail, when the first detecting portion detects the open state of the open/close portion and the second detecting portion detects that the cartridge is dismounted from the image forming apparatus, the control portion 200 controls the switching element so as to be turned on.

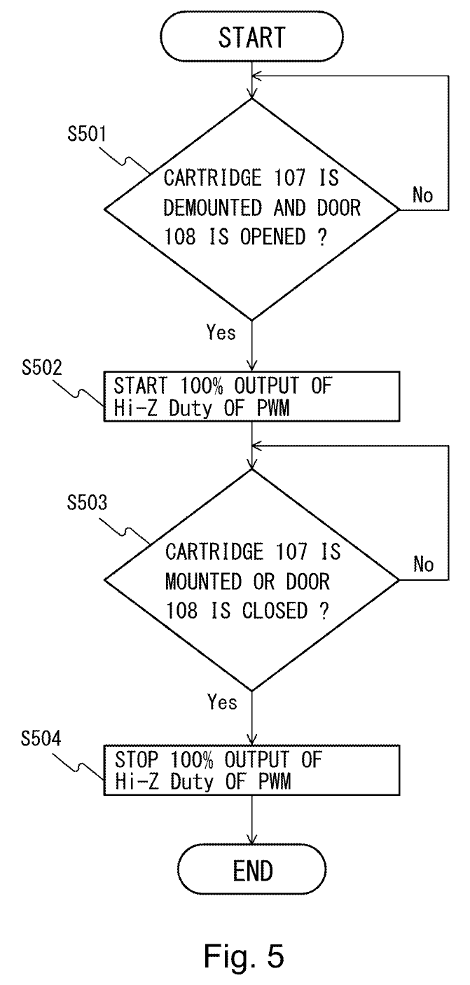

As the mounting/dismounting detecting portion 230, a detecting circuit similar to the door open/close detection circuit 220 for the door 108 may be used, or it may be detected by other means. The control portion 200 determines whether the cartridge 107 is mounted or dismounted based on the detection result of the mounting/dismounting detecting portion 230. A control flow for this will be described using FIG. 5. In the description for the Embodiment 2, only parts different from the Embodiment 1 will be described, and description for parts which are the same as the Embodiment 1 will be omitted.

### Protecting control for the switching element in the Embodiment 2

In S501, the control portion 200 determines a mounting/dismounting state of the cartridge 107 based on the detection result by the mounting/dismounting detecting portion 230, and determines the open/close state of the door 108 based on the detection result of the door open/close detecting circuit 220, respectively. Specifically, the control portion 200 determines whether the cartridge 107 is dismounted and the door 108 is open. In S501, if the control portion 200 determines that the cartridge 107 is mounted or the door 108 is closed, then returns the process back to S501. In S501, if the control portion 200 determines that the cartridge 107 is dismounted and the door 108 is open, then proceeds the process to S502. In S502, the control portion 200 outputs the PWM signal so that the duty of Hi-Z state thereof becomes 100%. It can be said that the process in S502 is a control in which the control portion 200 causes the switching element Tr31 to be turned on.

In S503, the control portion 200 determines whether or not the cartridge 107 is mounted or the door 108 is closed. In S503, if the control portion 200 determines that the cartridge 107 is dismounted and the door 108 is open, then returns the process back to S503. In other words, the control portion 200 keeps the protecting operation for the switching element Tr31 while the cartridge 107 is dismounted and the door 108 is in the open state. In S503, if the control portion 200 determines that the cartridge 107 is mounted or the door 108 is closed, then proceeds the process to S504. In S504, the control portion 200 stops the protecting control for the switching element Tr31, i.e., in order to shift to the control associated with the image formation, stops the output of the PWM signal of which the duty of Hi-Z state is 100%, and terminates the process. It can be said that the process in S504 is a control in which the control portion 200 causes the switching element Tr31 to be turned off.

In this manner, according to the Embodiment 2, it becomes possible, with the inexpensive circuit configuration, without applying the power source voltage to the developing roller, to protect the switching element from the steep electrical noise such as ESD. As described above, according to the Embodiment 2, in the circuit configuration in which another voltage is generated from the single high voltage circuit, it becomes possible, with the inexpensive configuration, to protect the switching element even against the steep electrical noise.

### Other Embodiments

The present invention may also be realized by a process in which a program realizing one or more functions of the Embodiments described above is supplied to the system or the apparatus via a network or a storage medium, and one or more processors in a computer of the system or the apparatus read out and execute the program. In addition, the present invention may also be realized by a circuit which realizes the one or more functions (e.g., ASIC).

According to the present disclosure, in the circuit configuration in which another voltage is generated from the single high voltage circuit, it becomes possible, with the inexpensive configuration, to protect the switching element even against the steep electrical noise.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2025-033730, filed March 4, 2025, which is hereby incorporated by reference herein in its entirety.

What is claimed is:

1. An image forming apparatus which a cartridge provided with a first member and a second member is mountable to and dismountable from, the image forming apparatus comprising:
an open/close portion configured to take an open state in which the cartridge is mountable to and dismountable from the image forming apparatus and a closed state in which the cartridge is restricted from being mounted to and dismounted from the image forming apparatus;
a first circuit configured to generate a first voltage to be supplied to the first member;
a second circuit provided with a switching element configured to generate a second voltage, to be supplied to the second member, by dividing the first voltage;
a controller configured to control turn on and turn off of the switching element; and
a detecting portion configured to detect the open state of the open/close portion,
wherein the controller controls the switching element so as to turn on when the detecting portion detects the open state of the open/close portion.

2. The image forming apparatus according to claim 1, further comprising, when the detecting portion is defined as a first detecting portion, a second detecting portion configured to detect that the cartridge is dismounted from the image forming apparatus, and
wherein when the first detecting portion detects the open state of the open/close portion and the second detecting portion detects that the cartridge is dismounted from the image forming apparatus, the controller controls the switching element so as to turn on.

3. The image forming apparatus according to claim 2, further comprising
a first electric contact configured to electrically connect to the first member, and
a second electric contact configured to electrically connect to the first member,
wherein in a state in which the open/close portion is in the open state and the cartridge is dismounted from the image forming apparatus, the first electric contact and the second electric contact are exposed so as to be contactable by a user.

4. The image forming apparatus according to claim 3, wherein when the cartridge is mounted to the image forming apparatus, the switching element is electrically contacted to the first electric contact and the second electric contact.

5. The image forming apparatus according to claim 4, wherein the second circuit is provided with a resistor; and
wherein the second voltage is generated by the first voltage being divided by a voltage drop of the resistor and the switching element.

6. The image forming apparatus according to claim 5, further comprising an operational amplifier provided with an input terminal and an output terminal,
wherein the controller sends a signal to the input terminal of the operational amplifier,
wherein the output terminal is connected to a base terminal of the switching element, and
wherein the switching element switches between a turn on state and a turn off state based on the signal sent from the output terminal.

7. The image forming apparatus according to claim 6, wherein the controller causes the switching element to be turned on by sending the signal of which duty ratio is 1 to the input terminal when the detecting portion detects that the open/close portion is in the open state.

8. The image forming apparatus according to claim 1, wherein the first member is a charging roller configured to uniformly charge a surface of a photosensitive drum, and
wherein the second member is a developing roller configured to develop a latent image formed on the photosensitive drum with toner.
